(19) United States
(12) Patent Application Publication
(10) Pub. No.: US 2007/0265888 A1
(43) Pub. Date: Nov. 15, 2007

(54) Healthcare management system

(76) Inventor: Dario Dante Castelli, Pittsburgh, PA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/800,790

(22) Filed: May 7, 2007

Related U.S. Application Data
(60) Provisional application No. 60/799,832, filed on May 15, 2006.

(51) Int. Cl. G06Q 10/00; G06Q 40/00

(52) U.S. Cl. 705/4; 705/2; 705/1

(57) ABSTRACT

A method of healthcare management wherein set required standards of healthcare for insured participating physicians are controlled by the physicians liability insurer. The required standards include requiring audio or audio visual recording, and retention of such recordings, of consultations between the participating physician and a patient, and upon the occurrence of a malpractice claim by a patient, evaluating the claim as to whether litigation is warranted or unwarranted. Such evaluation includes at a minimum review of the audio recording by the participating physician, the patient and the physician's liability insurer. Additional parties, such as the court, may be involved in such evaluation as necessary. The patient is awarded compensation in cases of warranted litigation in accordance with the evaluation, and malpractice insurance premiums are reduced for the participating physicians.

### CROSS REFERENCES

Applicant claims the benefit of U.S. Provisional Patent Application No. 60/799,832, filed on May 15, 2006.

### BACKGROUND OF THE INVENTION

The present invention pertains to total healthcare reform and more particularly to a method of healthcare management.

Proposals in various levels of completion are attempting to resolve the healthcare crisis today by addressing the financial and legal responsibilities of the HMO's, the healthcare providers, and the insured. Resolution of these issues would fall short in bringing about any serious healthcare “reform”. Reform as defined by the Random House College Dictionary Revised Edition is as follows: 1. The improvement or amendment of what is wrong, corrupt, unsatisfactory, etc . . . 2. The amendment of conduct, belief, etc . . . 3. To change to a better state, form, etc . . . 4. To cause a person to abandon wrong or evil ways of life or conduct. 5. To abandon evil conduct or error. Central issues which involve these descriptions must be identified and modified or eliminated to establish total healthcare reform.

Clarifying terminology, delineating responsibilities, and directing duties of the parties involved focuses on problems pertaining to contractual law; dealing with legal terminology and the responsibilities between a corporate entity and its customer, and the contractual obligations between the corporate entity and its employee, again dealing in contractual law. If that is the extent to which the proposals are addressed, then the obligations, these obligations, rights, and duties could be established. However, if the intent is the establishment of an entire healthcare directive, then resolution of contractual issues will resolve contractual conflicts but will not bring about total healthcare reform. If all of the problems relating to the obligations, rights, and duties of these contractual agreements were resolved would low cost, high quality managed health care be achieved? Let's examine first what the healthcare problem is and how it developed.

### Three Causes of the Healthcare Crisis

Forty to fifty years ago, the medical field was able to provide the best possible care available at that time at a reasonable cost. Medical advances, developing out of necessity during World War II, were introduced to the civilian population following the war. New surgical and investigative procedures, advanced treatments, and sophisticated monitoring as well as diagnostic equipment were developed during the war effort. Training of the civilian physician population in the newer methods of medical care, production and maintenance of the technologically more complicated equipment, and introduction of pharmalogically newer methods of disease control began to increase the cost of medical care. As newer insights into the disease processes were discovered and newer avenues for disease control or eradication were found, the prospect of increased medical costs emerged. Research and development and the expensive production costs of sophisticated technical equipment and pharmaceutical agents began to take their toll on the cost of providing healthcare for the American family. Health insurance premiums were climbing beyond the reach of an increasing percentage of the population. A vicious circle of increased sophistication of medical care, re-training of medical personnel to perform newly developed procedures, the development of sophisticated equipment to diagnose and treat the disease processes, trained personnel to maintain and service new equipment, increased understanding of the disease processes resulting in newer techniques to treat the diseases, and re-training of the medical personnel in the newer methods of medical care created a steadily worsening situation in the cost of providing medical care.

Besides the expenses resulting from the provisions of a blossoming and fruitful technology, there were needless, financially draining undercurrents of expenses, infiltrating and increasingly pervading through larger and larger areas of the medical field.

One such expense arose from these technological advances. Combined with the expected increased expenses of providing the technological advances of quality medical care, a rising, inappropriate and unnecessary abuse of these provisions began to create an unbearable economic situation on the citizens of this nation by adding greater and greater financial burden to the cost of providing medical care by the insurance companies and their subscribers.

The majority of practicing physicians provided ethical, humanitarian, and self-sacrificing care to their patients. However, a small but growing number of physicians developed a greater interest in the financial rewards that could be gained from this vocation rather than the altruistic rewards the profession provided. By adding to this group an additional unmeasurable percentage of physicians intent on making financial gain at the expense of the healthcare system through fraud, the prospect of affordable medical care disappeared as the premiums rose to shore up the financial reserves of the insurance companies being drained by a group of greedy, unethical, or fraudulent physicians.

As our society became more litigious, the medical profession suffered a dramatic rise in warranted and unwarranted malpractice claims by patients against their physicians. These settlements substantially increased the malpractice insurance premiums, premiums paid by all physicians, whether personally involved in litigation or not. The cost of paying these additional premiums was passed onto the patient and health insurance companies in the form of increased fees for any services rendered by the physician.

These three unnecessary expenses, therefore, contributed to the increasing cost of health insurance premiums subscribers were required to pay for healthcare. First, payments the insurance companies were required to make for the increased cost of performing unnecessary diagnostic tests or treatments using more sophisticated equipment, and the payments of fees required for the services of trained specialists. Second, payments the insurance companies were being fraudulently billed by an inestimable percentage of the medical profession who were filing claims for procedures not performed, not required, or in lieu of tests or procedures more appropriate and more informative, but financially less remunerative. Third, malpractice settlements from an increasing number of patients against their physicians increased the cost of acquiring malpractice insurance for all physicians and raised every physicians' office expenses; which necessitated an increase in physicians fees to the patients, and to the insurance companies, who compensated by raising the cost of health insurance premiums to the subscribers. These three factors combined to create a devastating situation wherein the cost of health insurance premiums were driven so high that individuals and families of this country were completely unable to afford healthcare insurance, opening the door to incorporation of the HMOs into the healthcare systems.

### Citizens and the new Healthcare Organizations

Citizens were desperate for relief from the rising cost of health insurance premiums. In an effort to obtain medical insurance at an affordable price, the subscribers sought coverage through healthcare organizations which offered benefits at extremely low cost with a promise of substantial medical benefits. Necessary to care for these subscribers, physicians were enticed with the promise of new patients and near parity payments for services rendered. Once enrolled it soon became obvious to all that the provisions to the subscribers and providers had been exaggerated and the quality of medical care would suffer.

### Medical and Financial Goals of the HMOs

One of the problems facing managed healthcare organizations is that Medicine and managed healthcare have vast and irreconcilable differences with regard to their operating principles. Managed (from the Latin mans-hand; to handle. regulate, control, contrive) healthcare organizations were not founded on healing principles of medicine but on business principles of regulation, which when transposed for medical principles can border on the unethical. Managed healthcare organizations regulate how the subscriber receives care, but do not regulate in the direction of providing better care to the subscribers in an effort to help them regain their health. Rather, their foundation is established on business principles regulating in the direction of providing the least care possible to the subscribers in an effort to reduce expenses and retain a greater profit. Greater care, through the use of medical technology and the skills of the specialist, means fewer profits and less care means greater profits. The extent of the profits desired determined the extent of the benefits or care provided, even so far as to providing substandard levels of care to the detriment of the patient's health as service for the premium payments. Whereas, Medicine is founded upon humanitarian principles, attempting to provide the best care available for the patient, managed care is founded upon economic principles providing the least care possible for the patient.

The goal of managed healthcare is profit. The quality of patient care means little to the managed care organizations other than the fact that quality is synonymous with increased cost, and increased cost means less profit. By denying the subscriber appropriate studies or treatments recommended by a qualified physician, the managed care organization have demonstrated a callous lack of concern for the health of their subscribers, irregardless of the health risks that their decisions pose, or the accuracy of the physician's recommendation. In addition, by encouraging care by less trained, less experienced, and less qualified non-specialists, the corporations, while free from litigation, have increased their profits at the expense of malpractice exposure to the physician and inferior healthcare to the patient.

### The Physician and Technology

The goal of the physician is the care and healing of the patient. All effort is to be appropriately directed towards using whatever tools are necessary to properly diagnose disease processes, and employing all methods available to effectively treat the patient, alleviate the symptoms, or eradicate the disease. Purchasing and maintaining complex equipment, and the training of personnel to operate the equipment, makes the cost of providing advanced diagnostic procedures expensive. In some situations sophisticated equipment may not be necessary for establishing an accurate diagnosis. However, in many situations these sophisticated tools are crucial in establishing an accurate diagnosis for the treatment of the patient. As is the case in any business or mechanically technical profession, specific tools have been designed to perform specific tasks; and in a constantly changing environment, the equipment must be constantly modified and the individuals re-trained to appropriately perform their tasks. Similarly, in the medical profession, sophisticated equipment must also play an integral part in the performance of indicated tasks; and these tasks aid the physician in the diagnosis and the treatment of the patients disease. In Medicine, as in the other professions or businesses, this technologically advanced medical equipment must also be constantly modified and the individuals re-trained as the understanding and diagnosis of the disease processes improves and the treatments become more successful. The availability of more successful, sophisticated equipment or materials for the treatment of the patient soon becomes the standard of care for the community, and any care which does not include newer, available, and potentially more successful treatments becomes an issue of malpractice. Since the physician is morally, ethically and legally bound to perform his tasks to the best of his abilities, it is reasonable that all effort, incorporating the most accurate or effective diagnostic or therapeutic tools available, should be utilized to restore the patient's health. This does not mean, however, that the most advanced technology is necessary in all situations for the care of the patient, when the diagnosis or treatment of the disease can be accomplished with less aggressive or expensive means. Prudence must be used to judiciously determine the appropriateness in each situation. However, if it is known and generally accepted that the more sophisticated approach is necessary for the diagnosis or treatment of the disease, or if it is seen that a patient's treatment has been unsuccessful for a reasonable trial period, then the more sophisticated approach should be utilized. How can it be known with certainty that the advanced technology is being used at the appropriate time and not prematurely or inappropriately, thereby raising the cost of medical care?

### The Errors and Shortsightedness of the HMOs

The managed care organizations failed to accurately identify and systematically resolve all of the factors contributing to the problem of the outrageously high cost of obtaining healthcare insurance. In searching for the cause of the problem, they focused their attention on the obvious, the most expensive, and the most accessible; the diagnostic and therapeutic charges and the fees for specialist's services. By denying the subscribers access to these studies, treatments, or evaluations, the managed care organizations could generate a substantial profit from the savings, while providing low-cost healthcare to a large volume of subscribers. Managed care had failed to identify the other causes of exorbitant premiums, and by failing to identify and address all three causes, cost-cutting was limited to one narrow segment, which they attacked with ruthless abandon. Decreeing these expensive parameters of medicine expendable, they eliminated them in order to insure low premiums while maintaining high profits. Their shortsightedness was the failure to expect such a public outcry and governmental response to these restrictions when these charges reflected fees for a necessary level of diagnostic and therapeutic treatment which, when judiciously used, are an integral and inherent part of the practice of quality medical care. These studies are an essential part of medicine that provides the capability of allowing the diagnosis of diseases on a structural, cellular, biochemical, or genetic level through optical, electromagnetic, and computer enhanced radiologic examination far beyond that which could have been imagined just a few years ago and are poised to open great vistas in medical care in the near future. The financial burden of technology in the escalation of premiums is not due to the use of technological sophistication but the miss-use of these facilities.

By the same token, managed care failed to see that the proliferation of specialists proceeded from the inability of the general practitioner to read, understand, and incorporate the volumes of new information necessary to treat each and every system of the body with excellence; whereas, the specialist devotes all professional time and energy into the understanding and treatment of the intricacies of a specific topic or organ system. The specialist, therefore, is able to act as consultant in the treatment of diseases, enhancing, and directing the knowledge and skills of the general practitioner, and treating those diseases beyond the general practitioner expertise. By pressing for nearly total care by the general practitioner rather than an appropriate specialist, the managed care organizations are encouraging the practice of inadequate medicine and courting possibilities of numerous malpractice claims. At this time, the courts have ruled that managed care organizations can not be held accountable for their actions, with the result being that the responsibilities for any claims fall upon the physician. However, if ruled accountable, the legal and financial responsibilities could cause the collapse of the managed care organizations, leaving many individuals and families stranded without health insurance.

### Technology Versus Quality

The key word in the managed care dispute is “quality”. Managed healthcare has been able to provide healthcare at a drastically reduced rate by deleting medical options which they considered a luxury in providing healthcare to their subscribers. These “luxury” items were the items which constituted the “quality” in healthcare. Managed care had evaluated the problems of the health insurance companies and the difficulties subscribers were having in obtaining health insurance due to the high premiums. Having assessed the situation, they felt that by eliminating the most costly benefits the established insurance companies permitted, healthcare could be provided with low premiums. The targets of managed care were the more advanced diagnostic, technological and therapeutic benefits, as well as the referral system to specialists. Examples of luxury items would include an evaluation or treatment by specialists, CT scans, MRIs, ultrasound, physical therapy, etc. Where necessary these tools provide a necessary adjunct in the armamentarium of the prudent conscientious physician. By using these facilities appropriately, the physician can effectively diagnose and treat the patients' diseases. The modem physician has come to rely on these aids in order that he may be able to perform his profession with greater certainty and skill. Judicious use of these devices can prevent misdiagnosis, inappropriate treatment, delayed recovery and long term disability. Across the board denial of these facilities is creating a cost to the individual and society immeasurable in damages in comparison to the savings afforded managed care systems that are intent on healthcare for profit at all cost. If prolonged recuperation, permanent disability, and death for the patient and overwork, inadequate pay, escalating malpractice premiums, financial ruin and forced retirement for the physician are the costs for the course that managed care has chosen, are the savings worth it? How can we ensure appropriate and judicious use of these facilities by the physician in order that the cost of receiving medical care can be reduced?

### The HMO's Effect on Healthcare

The managed care organizations promised substantial healthcare with reduced premiums to their subscribers, and near parity payment to the physician for services rendered, which they refused to provide; but not because of financial reasons based upon insufficient funds. Instead, the patients were provided substandard and deteriorating care, the physicians and other healthcare providers were paid substandard and deteriorating wages, and the managed care organizations were diverting the profits to the corporation and the executives heading these corporations. Without accountability, the managed care organizations have seriously damaged the quality of healthcare in the United States by denying appropriate medical care and prolonging suffering, to the detriment of the health of the citizens of this country, while breaking the back of the healthcare system by deleteriously altering the care the physicians can provide their patients, and depriving the physicians their ability to earn a reasonable income, incurring financial losses sufficient enough to force retirement, while managed care gains exorbitant company profits. These healthcare profits were squandered, not reinvested back into health related services. Their methods are completely contrary to the founding principles established in the vocation of medicine. Healthcare by the HMOs, or by the contractually modified HMOs, can't provide the medical care that the citizens need, want, or can obtain at a reasonable rate. Who will bring about total healthcare reform, which needs someone to champion the task of addressing the problems at the core of the healthcare crisis today?

### Contractual Issues

These corporations have clearly taken unfair advantage of individuals who have nowhere else to turn for their healthcare needs, and by discouraging and, in many circumstances, refusing to permit appropriate care are making exorbitant profit from that persons misfortune, and causing frustration and fear for their health on the part of the subscribers. Almost everyone who has had experience in trying to receive appropriate healthcare from the HMOs will attest to these facts. This healthcare crisis is deplorable, intolerable and frightening, but what can be done. All will agree that this situation is unacceptable and that the care of the patient must go back to the physician, and that the physician must be able to care for the patient appropriately, and that all healthcare providers must be paid appropriate fees, and that the patients must have right to choose their physician, and on, and on, and on, expressing innumerable demands for patient rights and physician rights, but resolution of these contractual problems will not solve the problem that increasing quality will increase cost, and the subscribers need quality at low cost.

### Contractual Issues Alone can't Work

Can managed healthcare provide a standard of care approaching the previous quality of medical care? Not with current premiums, nor with the current financial structures of established managed healthcare organizations. It must be remembered that managed care's very existence relies upon their ability to deny services for subscribers, and on this foundation they were built. Denying services allows managed care to continue and make a profit from the premiums. Without the capability of denying subscribers' benefits as the basis of their financial structure, managed care could not exist. All attempts to bring back quality care, in the form of increased benefits, will increase healthcare premiums by nature of the fact that charges for specialists, advanced diagnostic studies, and therapeutic treatments will increase the cost to the insurance companies and the insurance companies will increase the subscribers' premiums or decrease the physicians' fees. If the managed care organizations are obligated to reinstate benefits to subscribers without increasing premiums or decreasing fees, there will be a failure of the managed care industry.

We are already seeing the beginning of this failure due to the salary abuses and the miscalculation that, eliminating the expenses created by the technological and specialist services, premiums would be sufficient for the company to be profitable. With or without the necessary expansion of benefits through current legislation, further failures and likely collapse of the managed care industry can be expected.

Managed care organizations have selectively reduced the cost, but have reduced the quality to accomplish it; whereas, legislation is attempting to increase the quality without increasing the cost to accomplish it. The first is objectionable to the subscribers, the second is objectionable to the insurance companies. From the beginning, the problem has been that the managed healthcare organizations have misdiagnosed the whole cause of excessive cost of health insurance premiums and by misdirecting their solution to inappropriately treating the symptoms of the disease and not the cause of the disease have nearly killed the patient and the medical care system.

The drastic, restricted, and overzealous approach by the managed care organizations forces subscribers to suffer with substandard healthcare and the prospect of increasing premiums; while the burden of an increased work and patient load, loss of income, loss of specialists, increasing malpractice claims, and financially forced retirements await the physicians. The failing quality of medical care and the spiraling collapse of the medical profession looms on the horizon. Through greed, irresponsibility, callousness and medically unethical behavior, HMO sponsored healthcare is about to destroy the healthcare system. The erroneous evaluation, poor judgement, and inappropriate and inexcusable behavior by the managed care organizations have brought medical care to the brink of disaster.

### Changes other than Contractual

Changes in areas other than contractual must be secured before reform can be accomplished. Attempting to fill the contractual gaps in a piecemeal fashion won't work. To get back to full quality care, managed care will have to get back to full premiums. The savings obtained by limiting technology and specialists by managed care will be negated by the greater losses through increased fraud and malpractice. There will be an increasing temptation for fraud and malpractice on the part of the physician, as their incomes dwindle, and a rise in malpractice claims resulting from an increased patient load, an increased number of specialty procedures performed by general practitioners, a decreased use of supportive technology for accurate diagnosis or treatment, and a medical profession staffed by younger physicians lacking the education gained by years of experiences.

In revamping healthcare, the problems at the root of the healthcare issue must be corrected by the establishment of governing principles and requirements for healthcare reform to occur. Quality medical care is rapidly crumbling and soon may not be correctable by any method. A system of checks and balances must be implemented to establish and secure the appropriate conduct for the practice of medicine; for the principles of medical excellence when resurrected and enacted appropriately will bring about the reform everyone wants. Re-establishment of the foundation of accountability is critical. High moral and ethical standards of integrity are required. All other approaches that deal only with healthcare contract issues, rather than the re-establishment and enforcement of the central basic tenets of appropriate medical care as originally intended for the patient, will fail to bring about quality healthcare at an affordable price.

Once we focus our attention onto excellence and accountability in caring for the patient utilizing whatever appropriate resources are necessary for the diagnosis of diseases and care of the patient, and redirect the energies of the physician towards excellence in healthcare of the patient without fear, reform will occur and the standard of care will far surpass that which has ever been, and accomplished without spiraling escalation of healthcare costs.

### SUMMARY OF THE INVENTION

The present invention is a system of checks and balances which will introduce the approach intended to correct the problem in phases. This phased approach would permit immediate financial and litigious relief to the physician, as well as health insurance relief to the insurance companies and the subscribers, by the employment of a first phase that is field ready. The benefits from the first phase would be obtained while the second and later phases were being developed and introduced. Progressing sequentially and incrementally, introducing each phase and portions of each phase as they are developed, provides cumulative advantages for the patient, the physician, the legal and the healthcare systems.

The efforts used to enact healthcare reform do not have to be complicated to ensure success. Centered in this program is the fact that the health care professional must be held accountable to the highest standard of excellence. The breadth and the severity of the consequences which result when the principles are compromised can be catastrophic. Therefore, the solution to these problems would involve provisions in the framework of the healthcare policies for encouragement of responsible medical care, verification of the fulfillment of these responsibilities, and discipline for those individuals failing to carry out their responsibilities. Since this provision for healthcare reform needs to be, and can be established quickly, the first portion, Phase One, would involve accurate verification of patient-physician interaction. The next provision, the initial portion of Phase Two, would be to delegate the contents of what is considered to be extensive informed consent disclosures. The remainder of Phase Two would be relegated to the development and distribution of the printed informed consent disclosures supplemented with written and supportive graphic materials. The next, Phase Three, will initially provide approved sequential investigative protocols, to be followed later by protocols of the checklist format for the approved treatment and procedure sequences.

To summarize the invention more precisely, the method of healthcare management of the present invention is a system wherein set required standards of healthcare for insured participating physicians are controlled by the physicians liability insurer. These set required standards at a minimum include requiring audio or audio visual recording, and retention of such recordings, of consultations between the physician and a patient. Upon the occurrence of a malpractice claim by a patient, the claim is evaluated as to whether litigation is warranted or unwarranted. This evaluation includes a stepwise review of the audio recording by the participating physician and the patient. Such evaluation can additionally include others, such as the physician's liability insurer, an arbiter and the court system if necessary. The patient is awarded compensation in cases of warranted litigation claims in accordance with the evaluation, and finally, the malpractice insurance premiums for participating physicians are provided at a reduced rate.

Further requirements include the requirement that the physician follow a prescribed protocols of topics which must be covered in the recorded consultation. In addition, it may be required that the physician provide the patient with prescribed prepared informative literature pertaining to a disease diagnosed by the physician, the literature including information, at a minimum, pertaining to possible risks, complications and treatments.

Further, the method of healthcare management of the present invention may additionally include the requirement for the physician to follow a prescribed progression of investigative studies intended to culminate and correct diagnosis of the patient's disease, and a requirement that the physician follow a prescribed progression of approved procedures for treating the diagnosed disease. Selected of these studies and/or procedures may be designated with distinguishing barcodes for convenient system management.

### BRIEF DESCRIPTION OF THE DRAWINGS

Other objects and advantages appear hereinafter in the following description and claims. The accompanying drawings show, for the purpose of exemplification, without limiting the scope of the invention or the appended claims, certain practical embodiments of the present invention wherein:

FIGS. 1A and 1B are connected flow charts illustrating the first phase of the healthcare management system of the present invention in cases of warranted and unwarranted professional liability litigation.

### DETAILED DESCRIPTION OF THE PREFERRED EMBODIMENTS

As previously summarized, the healthcare management system of the present invention is structured in a series of phases, wherein the first phase is the most basic phase of the method of the present invention. Phase one of the method of the present invention may be practiced independently and separate from phases two and three, however, in order to provide more complete healthcare reform, phase one is preferably followed-up by the requirements of phases two and three.

### Phase One

Phase one will incorporate audio recording of all office visits to ensure privacy, encourage informed disclosure, and supplement record-keeping. Obtained in the appropriate designated fashion, audio or audio visual recording would serve to ensure maximum privacy and security for the patient. Whereas, standard record-keeping currently used for medical charts allows access to personal information by the transcriptionist and perusal by office personnel at their convenience; audio recording will ensure that the details of the consultations would be available only to the physician with a concise, pertinent, and edited version for transcription. It must be remembered that typewritten documentation can be easily read, examined and copied; whereas, audio taped documentation appropriately performed would require extensive access and time to retrieve. The patient would be told before the consultation that the discussion would include all information that she presents, and that any information that she does not wish to have as a permanent part of her records should not be mentioned during the consultation. A provision could stipulate that certain unrelated information which the patient wishes to present to the physician, could be discussed separately and, with notation, without recording.

The problems with the healthcare system have been thoroughly examined, and it has been determined that the complete accuracy of the contents of this communication between the physician and the patient are of utmost importance and forms the cornerstone of healthcare reform. The simplicity and undeniable accuracy of this approach are vital assets. ‘Tis a gift, to be simple’ where verification when necessary can be obtained with certainty of its validity, while the information was obtained with unobtrusive simplicity. It's simple, it's cheap, and completes its tasks powerfully and effectively.

Audio or audio visual recording of all office visits would guarantee accurate medical records. This method of record keeping is, in and of itself, of course, not new in other industries and, in fact, is being used with increasing frequency by corporations for verification of telephone conversations pertaining to stock transactions, billing discussions with utility customers, and other ventures requiring verification of the content of communications. Because of problems in the past, businesses have resorted to audio taping conversations as a means of verifying agreements or clarifying the contents of discussions. The discussants are notified prior to their conversation that the communication is being recorded for quality control. Similarly, because of problems in verifying the adequacy or inadequacy of informed disclosure for the patient in the past, physicians would also make use of audio taping as a means of verifying agreements or contents of discussions. The patient would also be notified, both prior to the office visit and also the actual consultation, that the discussion will be recorded for medical record purposes. Then the recorded consultation would be securely stored. The recorded office visits would contain more extensive information than dictated and transcribed; however, access to the recorded version would only be necessary if there were a legal dispute, since the printed chart would contain edited, acceptable, and precise information sufficient for the diagnosis and treatment of the patient.

Audio recording will make the physician more aware of the content and the quality of his consultation. This feature will help to encourage and improve communication between the physician and the patient, so that the patient will derive greater understanding about the diagnosis, the precautions, the available options, and the treatment plan; and the physician will feel more confident that, with this information that was provided or disclosed, the patient will have a greater likelihood of compliance with the instructions so that a better outcome might be achieved.

Phase One could be instituted immediately to drastically reduce the progression of disagreements that are unwarranted, based upon the recorded content of the communications between the patient and the physician, towards litigation. Disputes between individuals may be resolved at separate and progressive levels by: 1) Having the patient, or 2) the patient and the physician, review the elements of the conversation in question, in order that the demonstrable presence or absence of the remarks in dispute may be proven or disproven. 3) Presenting the disputes in question to an independent arbitrator for resolution of the problem. 4) Seeking legal counsel to review the documentation and offer opinion regarding the possibility of malpractice litigation. 5) Litigation. It is obvious that in this system of checks and balances there would be a vast amount of money saved by avoiding unwarranted, costly litigation. These savings could be passed onto the participating physician by the insurance company through reduction in the cost of malpractice premiums. Reductions in malpractice premiums for participating physicians could take place immediately in anticipation of the decreased financial obligations by the insurance companies. Non-participating physicians would receive no cost reduction, and may even be burdened by an increase in the amount of the premium payments expected, since the likelihood of malpractice claims would be statistically greater for these individuals.

Audio recording of office visits will also provide recorded evidence of the accuracy of the billing practices by proving or disproving the contents, the extent, and the time required for the office visit as well as the scope of the treatment provided. The effect of this provision would be an additional reduction in health insurance premiums for the participating subscribers through the discouragement of fraudulent practices by unethical physicians; prosecuting those individuals who are lying, or trying to deceive by appearing to follow the letter of the law, but not the intent of the law, for the purpose of obtaining a larger fee.

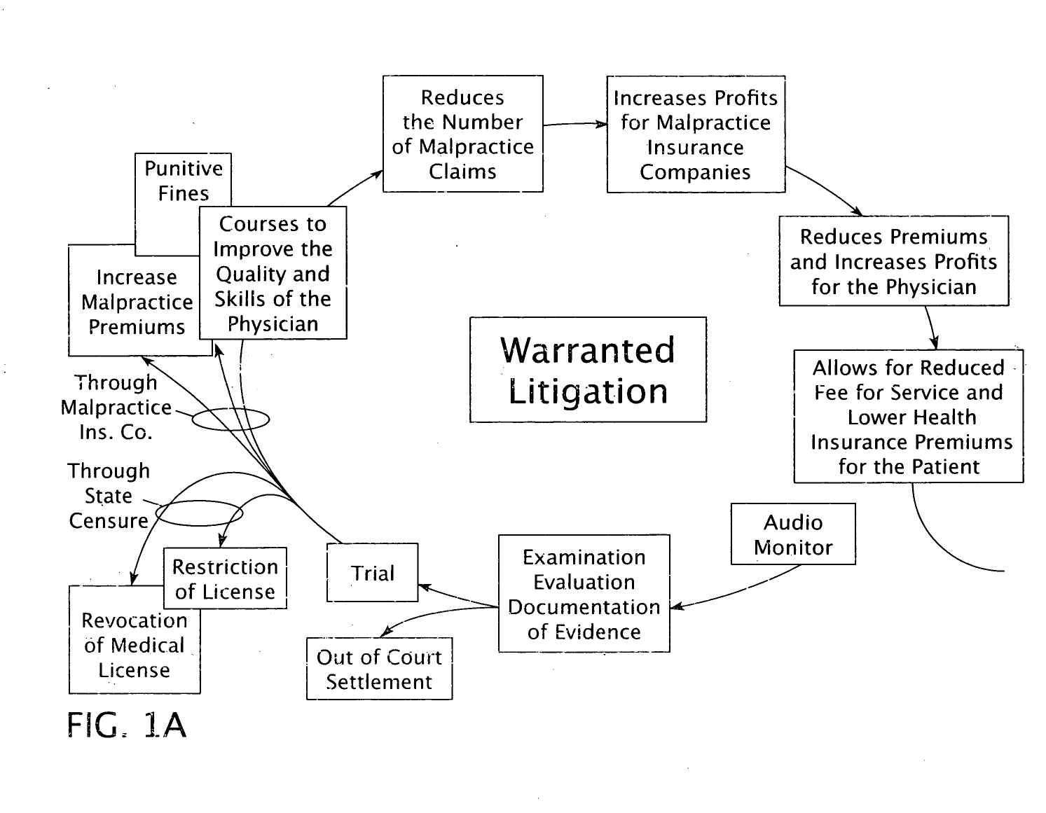

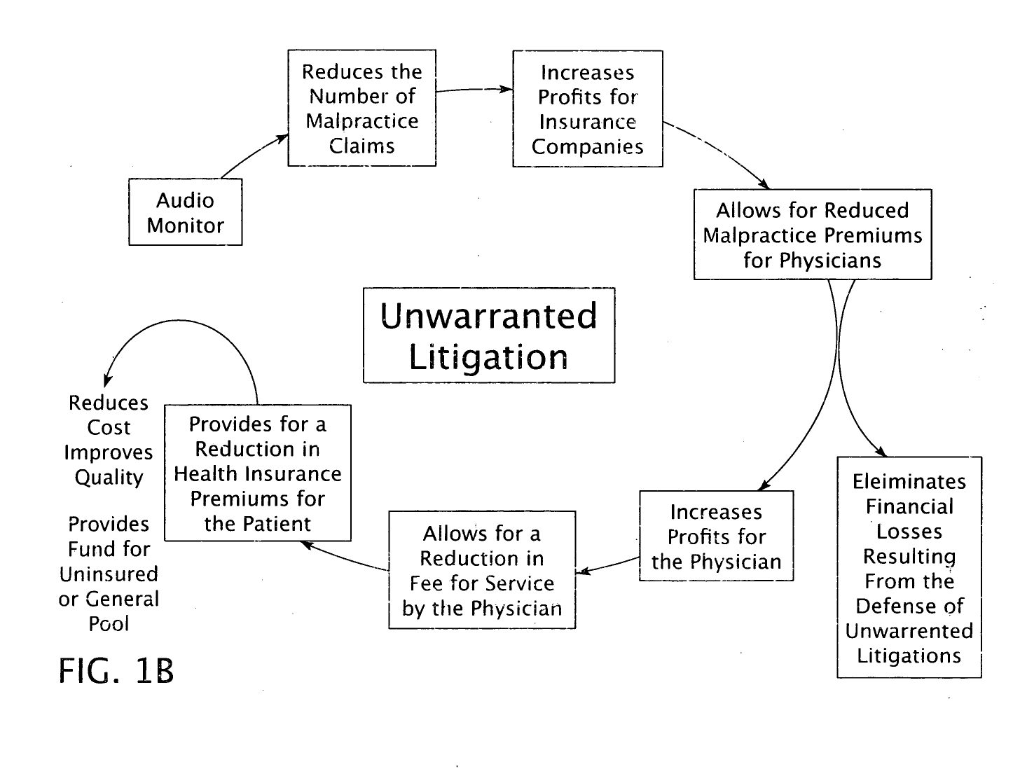

FIGS. 1A and 1B illustrate the advantages of phase one in the form of a flow chart illustrating litigation control in warranted and unwarranted litigation situations. The flow chart visualizes the flow of carrying out phase one as previously described, and additionally points out the advantages of the system.

In the case of unwarranted litigation, the method of the present invention can eliminate such unwarranted litigation through exact documentation of content of the communication between the participating physician and the patient. With fewer claims, malpractice insurance companies can improve profitability and at the same time reduce malpractice premiums, while increasing profits for the participating physicians. Also, as additional profits become available, more money is available to the participating physician for office staff and other expenses, and the participating physician and the insurer are not required to prepare for a defense against unwarranted litigation. In addition, the financial and emotional consequences for physicians and their families, defending against unwarranted litigation, are removed.

In cases of warranted litigation, the system provides undeniable evidence that establishes a physicians liability. Only then can justice be administered, confident of the physician's liability and certainty that the disciplinary actions taken are justified, without question or doubt, in that the following options are also warranted litigation the malpractice premium is for the liable position will be increased and punitive damages or fines may be administratively applied.

The negligent or liable physician may additionally be required to take further training, or courses to improve deficiencies in technical skills or concepts and disciplinary actions or restrictions of licensure for physicians involved for more serious violations, or repetitive offenses, may be applied. In the most serious cases, revocation of the physicians license would result causing the cost of malpractice insurance to ultimately decrease allowing for additional reductions in malpractice premiums while simultaneously improving the quality of medical care.

The audio monitoring system of the present invention encourages thoroughness and accuracy by the physician, provides verifiable evidence regarding the communication that occurred between the patient and the physician, secures privacy for the patient, reduces record keeping tasks and time for the physician and avoids the risk of unwarranted litigation for the patient and the physician.

The malpractice insurance company also benefits as its expenses for the defense of unwarranted and warranted litigation are reduced. The health insurance company also benefits with reduced expenses through the identification, verification and prosecution of fraud, or inappropriate or excessive charges. The system of the present invention also provides access to the health insurance company to appropriate patient information without violation of privacy.

The patient is also benefited in that the contents of the communication or consultation in question that may be the basis of a malpractice claim are clarified. In addition, the risk of unwarranted litigation is decreased and the patient's privacy is preserved and the patient maintains control over sensitive information.

### Phase Two

The first portion of Phase Two would essentially constitute the formulation of the directive, instituted and distributed, containing a protocol thoroughly enumerating the topics which must be included within the informed disclosure consultation. A large portion of malpractice cases are frequently initiated based upon disputes involving: adequacy of informed disclosure, available treatment options and the risks and consequences of each option, pre-operative preparation and post-operative management and expectations, the consequences if a recommended treatment by the physician is not followed by the patient, and the side effects and risks of medicinal treatments. In addition, questions of any implied or contractual agreements by the physician regarding timing or scheduling of procedures, or any financial or surgical responsibilities could be verified or refuted. These are examples of potential areas of disputes which would be offset by the audiotaped discussion in question.

The purpose of this provision is to set the standard, and the standard is excellence, in providing the patient all of the information available with the hope that the patient, under the guidance of the physician, could make an informed decision based upon an exceptionally thorough informed disclosure.

It has been shown that there is an inverse relationship between the amount of time spent communicating with the patient during office visits and the likelihood of a malpractice claim being filed against the physician. The study had shown that those physicians who spent at least eight additional minutes of time in active discussion with the patient were noted to have a significantly reduced history of malpractice claims. Because of the additional time, and presumably, the additional volume of information that was provided to the patient during that time interval, the patient had a more positive impression of the physician's concern for them as a patient. So that simply stated, those physicians who spend more time talking with their patients are less likely to be sued by their patients. This finding is of great value in stressing the importance of this second phase of total healthcare reform. How can this finding affirm the profitability of this phased approach towards total healthcare reform? Certainly this is not condoning a practice that the physicians spend additional time in an unproductive fashion in order to avoid litigation, or that the reason for spending the additional time is to avoid litigation, although it does. The additional time that would be necessary for the physician to present this thorough, structured, and organized presentation of the informed disclosure, expanding upon and clarifying the patient's disease process, the options available for treating that disease process, the complications and risks which can occur during those treatments and their consequences, et cetera. will help to create a rapport between the patient and the physician. This productive use of this additional office time will improve the physicians communication and the patients understanding. Should there be a complication following the proposed treatment, the established open communication pattern would encourage continued confidence in pursuing treatment towards improvement of the result. Hopefully, a better outcome may be achieved, a happier patient may prevail, and costly litigation may be avoided. The results of this study support the proposal for immediate reductions in the malpractice premiums of participating physicians as introduced in Phase One. This benefit is anticipated from the savings accumulated from the inauguration of Phase One, and further supplemented by the savings resulting from the initiation of Phase Two. It can be seen that this approach is opposite from the methods used by managed care to provide services to their subscribers. The governing principles used by managed care are driving the patients towards litigation and preventing the physicians from practicing medicine in a responsible fashion e.g., pressures of an excessive patient volume, decrease in time spent with each patient during the office visit, increased burden placed on the office staff in pre-approval and other services necessary to care for the increased patient load, etc.

The second portion of Phase Two would involve distribution of an approved illustrated printing, supporting and elaborating on the parameters involving indications, complications and risks, consequences and treatments, etc. Printed informed disclosure material would be given to the patient for review at their convenience, providing visual clarification and reinforcement of the consultation. It should be obvious that this portion of Phase Two should take longer to put into effect because of the amount of time required to organize, write and edit the information, and print and distribute the material. For less involved procedures, the amount of time required to formulate and distribute this information would be relatively short. However, as the complexity of the procedures increases so will be the amount of time required to assimilate, organize, edit, and distribute the information for each procedure. Since the completion times for each procedure could not be coordinated, it would be best to distribute the informative materials for each procedure immediately upon their completion, rather than delay distribution of the informative booklets until all of procedures have been finalized, combined, and the materials collectively sent.

### Phase Three

The first portion of Phase Three would involve the establishment of an approved progression of investigative studies intended to bring about the diagnosis of a patients disease. This provision would establish a sensible, efficient, and practical list of studies ranked in appropriate order that would provide pertinent data to effect a diagnosis. The cost effectiveness of the procedures would be considered, but the financial considerations would be evaluated in conjunction with its evaluative effectiveness. This could be standardized to incorporate a number of procedures within a given category. Many disease processes utilize a basic panel of studies in the initial stages of investigation up to a certain point. Beyond this point, the investigative studies needs change with each disease and diverge onto separate paths. When arriving at these departures diagnostic studies pertaining to each organ system could successively progress onto an approved pathway. This checklist would be disease centered and allow for parallel studies of other disease processes to be combined. This provision would allow a bypass verification for emergency purposes and unusual occurrence provision. This would serve three functions. The first would be the elimination of the overwhelming barrage of written and telephone communications seeking pre-approval, wasting time and personnel at considerable expense to the physician and the health organizations. The second would provide for immediate access for emergency situations. And the third, would be the provision of list non-invasive studies arranged in a specific order of acceptable implementation aimed at achieving a diagnosis considering and providing alternate pathways when necessary. The intent is to avoid the added medical risks of unnecessary invasive studies to the patient, as well as the additional, possibly fraudulent, expense to the medical community, while opening the door for the appropriate treatment needed by the patient in a timely fashion.

The second portion of Phase Three would involve the appropriate progression of approved invasive procedures for the treatment of diseases, pointing out in depth the indications, and comparative risks, consequences, expectations and benefits of the procedures elaborated in detail. This provision would help the patient understand and compare the short term and long term results of all available and applicable treatments or procedures so that, along with the physician, they could make an appropriate decision suitable for the patients' needs. It would inform the patient of procedural risks or consequences that could have potential long term deleterious health consequences which the patient may not wish to assume. It would also require the physician to point out the reason why a procedure would be more or less favorable and identify which procedures are more antiquated. This phase is designed to prevent the performance of unnecessary, inappropriate, and more hazardous procedures on the patient. Inappropriate surgery harms not only the patient, but also harms the healthcare system by raising healthcare costs. By performing unnecessary, inappropriate, or more hazardous procedures in lieu of the appropriate procedure, deleterious consequences can occur which require further hospitalization, additional surgery, medication, prolonged recuperation, wage losses, litigation, etc., placing tremendous emotional, physical, interpersonal, and financial burdens on the patient and the family. The financial burden would be shared by all of the subscribers of the insurance company, who will raise their premiums to reimburse the company s losses.

The next portion of Phase Three would incorporate the established national and/or regional boards of medical and ethical standards into the total scope of the proposal for low cost quality healthcare. With the initiation of the recorded office visits and the establishment of standardized acceptable and reasonable levels of informed disclosure, consecutive diagnostic studies, and informed disclosure regarding appropriate progression of invasive procedures and their risks, we have made provisions in the framework of the healthcare policies for encouragement of responsible medical care, and verification of the fulfillment of these responsibilities. With these predecessors, discipline can be administered, without equivocation, to those individuals who fail to carry out their responsibilities. Physicians who are repeatedly brought before the legal system for valid malpractice claims or fraud would be cited for investigation into the reasons for the repeated offenses. First offenses may be examined depending upon the situation. The boards' function is to determine the appropriate course of action necessary to rectify the situation. With a wide range of disciplinary methods available, the board is empowered to enforce their decision. A timely appeal process would be available to the repeat offender.

This process would serve to remove as quickly as possible, the physician in whom the financial gain from botched surgical procedures outweighs the shame of a blemished medical record or the small personal punitive damages awarded from a lawsuit covered under malpractice insurance. The burden of higher malpractice insurance premiums would be removed from the conscientious physicians forced to support the ongoing fraud of the greedy disreputable surgeons. In addition, it would force the discontinuation of procedures performed by inadequately trained physicians and allow the patient to seek the care of an appropriately trained surgeon or specialist. Patient confidence in the qualifications, capabilities, and concern by the physician would increase.

Phase three is a system of checks and balances which will provide precise guidelines, sequencing appropriate pre-approved medical care towards the ultimate in medical care and the elimination of medical malpractice. These guidelines may preferably be provided through a sequential barcode verification system of checks and balances, wherein each procedure and treatment will be classified by its own unique barcode identification, as well as the specific identification code for the ordering physician. The barcode portion will then provide recommended and approved sequential progressions for all of the ranges of diagnostic, medical, and surgical procedures within each category.

This system of checks and balances prevents malpractice through the use of a sequential, pre-approved progression of recommended tasks delineated for each specific medical, surgical or diagnostic procedure. Tasks within the sequence which have not yet been accomplished will be identified for completion. Those tasks within the sequence which have been completed will be blocked upon their completion to eliminate duplication and fraud. The sequential menus will be modified and supplemented as new procedures or revisions of previous procedures are accomplished. This will be accomplished with a computerized system that will be internet accessible and encrypted for data collection.

### Phase 4

With the checks and balances healthcare reform management system of the present invention, healthcare will be selectively standardized, revised and individualized. It will be standardized to a consistent level of excellence so that all subscribers may benefit equally from the advances in medical care as they become available. It will be revised as results indicating the effectiveness of the treatment become available from the physicians to the insurance company. Lastly, it will be individualized by the physician who will examine, diagnose and select the most beneficial treatment, to be modified if appropriate. Information relating to the results of treatment will be entered into the databanks and assessments will be made to determine which treatments are the most effective, yet provide the least risk of complications.

These processes will improve the quality and reduce the cost of medical care for the subscribers, and introduce new roles for the health insurance companies. The health insurance companies will achieve an important new position as the central communication center for the system utilized for the purpose of receiving, maintaining, processing and distributing data on the effectiveness of the various treatments available to the physician. Centralization of this information by the health insurance companies will advance the quality of medical care to the highest level of excellence, for the use of all subscribers equally. The quality, effectiveness and accuracy of the healthcare system will be evaluated and revised on a continuous basis, for the purpose of increasing quality and reducing cost more quickly. Centralization would also establish an important communication link to all physicians for rapid access to vital information for the prevention and treatment of communicable diseases, environmental toxins, threats or disasters. This centralization is brought about through the use of a centralized computer data processing system for tracking all the requirements imposed on the physician to ensure compliance.

A physician may become a member of the system of checks and balances of the healthcare management system of the present invention based upon agreements to comply with the standards required of the physician. Individuals who do not agree to follow the standards set forth in the system of checks and balances of the present invention will not be accepted, and members who fail to continue to meet those standards will be assessed higher malpractice premiums or discharge; these actions being based upon actuarial probabilities and not being punitive in nature. To achieve effectiveness and excellence within the system of the present invention, the health insurance companies must be capable of insuring compliance by the physicians. Motivation to comply will be accomplished by adjusting the level of malpractice insurance premiums paid by the physician, and health insurance premiums paid by the subscriber. Subscribers will pay lower health insurance premiums and receive higher benefits in their medical care coverage by selecting physicians within the systems of checks and balances of the present invention. Physicians will pay lower malpractice premiums because the number of litigations will decrease when using the system of the present invention.

Payments on a malpractice claim are made by the malpractice insurance company and are transferred to the injured party and their attorney, which is a financial drain of money out of the healthcare system. This monetary loss is reimbursed to the malpractice insurance company through an increase in premiums paid by the physicians to the malpractice insurance company. As a unit, the physicians act as representative agents of the physician who was legally responsible for the malpractice. By eliminating malpractice, we eliminate the financial drain from the healthcare system. All these drains close and more funds become available to support the physicians and fill the reservoir. However, active participation is required to eliminate the leakage of funds from the healthcare system. The checks and balance system of the present invention eliminates the leakage of the funds at its source. The primary source of the leakages is the physician and the primary cause of the leakage is malpractice.

### SUMMARY

Phase One: Audio taping will insure patient privacy by reducing transcribed documentation to pertinent and edited information. It will also reduce the financial drain on the physicians by preventing frivolous and unwarranted litigation which causes unnecessarily high malpractice insurance premiums. It will also relieve the physician of burdensome documentation by expensive transcription services by the office staff. It will also lower the health insurance premiums for the subscribers by pursuing and reducing physician fraud.

The liability or nonliability of the physician can be authenticated in cases of medical malpractice through the establishment of the more accurate, verifiable, undeniable and irrefutable evidence available, accomplished through the use of audio recordings that were obtained during the consultations. This system of checks and balances easily fulfills these requirements without the need for legislation. In addition, the time and expense of courtroom proceedings can be avoided in cases of unwarranted malpractice litigations through the use of the audio recordings obtained during the consultations. These recordings provide verifiable and undeniable, evidence as to the liability of the physicians in cases of unwarranted medical malpractice litigation.

Phase Two: Extensive informed disclosure will increase the patient's comprehension of the procedure by providing tangible educational materials elucidating the information presented during the consultation, thereby improving the patient-physician relationship and the physician's image. It will cover what would be considered thorough, reasonable and extensive disclosure and provide the subscriber with standardized explanatory and descriptive material to supplement the informed disclosure, reducing the number of malpractice claims that would be based upon inadequate informed disclosure.

Phase two provides uniform understandable, printed and illustrated materials relating to comprehensive informed consent depicting and explaining the nature of the medical problem, the problems available for treatment, the complications and the risks that can occur with the treatments and their consequences for thereby eliminating malpractice. This particular part of the solution is the all-inclusive informed consent portion of the system of checks and balances of the present invention.

Phase Three: The serial arrangement of investigative studies in menu format would delineate the approved sequence for the diagnosis of diseases. This would serve to remove pre-approval delays to allow for timely execution of diagnostic procedures. It would also provide direction for thorough studies without leap-frogging to more expensive procedures before appropriate preliminary studies. The menu of approved succession of procedures would avoid inappropriate, unwarranted, antiquated or unnecessary procedures without the required preliminary diagnostic studies for approval. This would prevent unnecessary medical risks to the patient as well as the financial burden to the medical care system by performing more lucrative procedures or studies when other approaches would be more appropriate. This would serve to reduce health insurance premium. It would also serve to provide the patient with extensive information, organized and presented in such a fashion as to allow an informed decision regarding treatment.

This portion of the system of checks and balances of the present invention prevents malpractice through the use of a sequential, pre-approved progression of recommended tasks delineated for each specific medical, surgical or diagnostic procedure. This is preferably accomplished through the use of a sequential barcode verification system wherein each procedure and treatment will be classified by its own unique barcode identification, as well as the specific identification code for the ordering physician. The barcode portion will then provide recommended and approved sequential progressions for all of the ranges of diagnostic, medical, and surgical procedures within each category. This facilitates operation of the system of the present invention with a computerized system which will be internet accessible and encrypted for data collection.

Phase Four: This phase pertains to accountability, enforcement and compliance. All of the information pertaining to the system of the present invention is centralized through the use of a centralized computer data processing system. In this manner the compliance by the physician can be readily tracked and the physicians are also provided with rapid access to vital information for the prevention and treatment of communicable diseases, environmental toxins, threats or disasters, and further as a means of tracking the physician's compliance with the other required phases of the system of the present invention.

Premiums will be significantly reduced for physicians free from claims of warranted malpractice litigation. However, malpractice premiums will be significantly greater for physicians found guilty of warranted malpractice litigations, and increasingly so for repeat offenders. In addition, other remedial options may also be imposed on the physician as well. This will serve to eliminate the financial drain caused by the few physicians who irresponsible actions place cumulative financial burden on other physicians through unaffordable malpractice premiums. Also, the insured health insurance subscribers who must pay increasingly greater and unaffordable health insurance premiums for medical care, and the many uninsured who are suffering under extreme physical, mental and financial strain should, under the guidance of the system of the present invention, be able to afford medical care for themselves and their families.

I claim:

1. A method of healthcare management wherein set required standards of healthcare for insured participating physicians are controlled by the physician's liability insurer, said standards comprising:
requiring recording, and retention of such recordings, of consultations between the participating physician and a patient;
upon the occurrence of a malpractice claim by a patient, evaluating the claim as to whether litigation is warranted or unwarranted, wherein the evaluation includes at a minimum, review of the recording by the patient;
awarding the patient compensation in cases of warranted litigation claims in accordance with the evaluation; and
reducing the malpractice insurance premiums for participating physicians.

2. The method of claim 1, including reducing healthcare premiums for the patient participating by selecting a participating physician.

3. The method of claim 1, including the requirement for the physician to follow a prescribed protocol of topics which must be covered in the recorded consultation.

4. The method of claim 3, including the requirement for the physician to provide the patient with prescribed prepared informed consent disclosures pertaining to a disease diagnosed by the physician, said disclosures including information pertaining to possible risks, complications and treatments.

5. The method of claim 1, including the requirement for the physician to follow a prescribed progression of investigative studies intended to culminate in a correct diagnoses of the patient's disease.

6. The method of claim 5, including the requirement for the physician to follow a prescribed progression of approved invasive procedures for treating the diagnosed disease.

7. The method of claim 6, wherein selected of said studies and procedures are designated with distinguishing bar codes.

8. The method of claim 6, wherein compliance of all said requirements are tracked through a centralized computer data processing system.
